(19) United States
(12) Patent Application Publication
(10) Pub. No.: US 2025/0362575 A1
(43) Pub. Date: Nov. 27, 2025

(54) LIGHT SOURCE DEVICE AND IMAGE DISPLAY APPARATUS

(71) Applicants: Tomoya FUJII, Kanagawa (JP); Sota HIRAHARA, Kanagawa (JP); Kasumi NAKAMURA, Kanagawa (JP)

(72) Inventors: Tomoya FUJII, Kanagawa (JP); Sota HIRAHARA, Kanagawa (JP); Kasumi NAKAMURA, Kanagawa (JP)

(21) Appl. No.: 19/192,405

(22) Filed: Apr. 29, 2025

(30) Foreign Application Priority Data
May 21, 2024 (JP) 2024-082778

(51) Int. Cl. G03B 21/20; G03B 21/14

(52) U.S. Cl. CPC G03B 21/204; G03B 21/142; G03B 21/2066; G03B 21/208; G03B 21/2013

(57) ABSTRACT

A light source device includes an excitation light source including: one or more light emitters to emit excitation light; and an optical element to convert the excitation light into an excitation beam; a wavelength converter; a dichroic mirror; a light homogenizer; a first condensing optical to condense the excitation beam onto the wavelength converter; a second condensing optical system to condense the excitation beam onto a first focal position on the incident surface of the light homogenizer; and condense the fluorescence onto a second focal position on the incident surface of the light homogenizer. At least one of a position or an orientation of one of the optical element of the excitation light source; the dichroic mirror; or the wavelength converter is adjustable to adjust the first focal position of the excitation beam and the second focal position of the fluorescence on the incident surface of the light homogenizer.

### CROSS-REFERENCE TO RELATED APPLICATION

This patent application is based on and claims priority pursuant to 35 U.S.C. § 119 (a) to Japanese Patent Application No. 2024-082778, filed on May 21, 2024, in the Japan Patent Office, the entire disclosure of which is hereby incorporated by reference herein.

### BACKGROUND

### Technical Field

The present disclosure relates to a light source device and an image display apparatus.

### Related Art

As a light source for an image display apparatus such as a projector, a head-up display, or a wearable display, a light source device is known that irradiates a fluorescent layer with light emitted from a semiconductor laser (LD) or a light-emitting diode (LED) as excitation light, causing the layer to emit fluorescence, and displays a color image using both the excitation light and the fluorescence.

In such a light source device, light beams forming three primary colors are combined in a time-division manner to display a color image. However, if the relative positions of the optical elements deviate from their designed alignment, the color temperature of the displayed image may change, resulting in color tone shifts, such as becoming bluish or reddish. This can degrade the overall image quality.

### SUMMARY

An embodiment of the present disclosure provides a light source device including an excitation light source including: one or more light emitters to emit excitation light; and an optical element to convert the excitation light, emitted from the one or more light emitters, into an excitation beam; a wavelength converter including: a reflector to reflect the excitation beam; and a phosphor layer to emit fluorescence having a wavelength different from a wavelength of the excitation beam; a dichroic mirror to: transmit the fluorescence; and reflect the excitation beam; a light homogenizer having an incident surface to homogenize the excitation beam and the fluorescence incident on the incident surface; a first condensing optical system having an optical axis to: transmit the excitation beam reflected from the dichroic mirror through one half of an optical effective surface of the first condensing optical system relative to the optical axis; and condense the excitation beam onto the wavelength converter; a second condensing optical system having the optical axis to: condense the excitation beam, reflected from the reflector of the wavelength converter and transmitted through an opposite half of the optical effective surface of the first condensing optical system relative to the optical axis, onto a first focal position on the incident surface of the light homogenizer; and condense the fluorescence emitted from the phosphor layer of the wavelength converter onto a second focal position on the incident surface of the light homogenizer. At least one of a position or an orientation of one of the optical element of the excitation light source; the dichroic mirror; or the wavelength converter is adjustable to adjust the first focal position of the excitation beam and the second focal position of the fluorescence on the incident surface of the light homogenizer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A, 1B, 1C, and 1D are diagrams illustrating a configuration of a light source device;

FIGS. 2A and 2B are diagrams illustrating the separation between the focal position of fluorescence and the focal position of reflected excitation light on the incident surface of a light homogenizer, caused by the inclination of a wavelength converter from its reference position;

FIGS. 3A, 3B, 3C, and 3D are diagrams of a light source device;

FIG. 4 is a diagram of a light source device;

FIG. 5 is a diagram of a light source device;

FIG. 6 is a diagram of a light source device;

FIG. 7 is a diagram illustrating an embodiment in which two light source devices are used;

FIG. 8 is a diagram of a projector as an image display apparatus;

FIGS. 9A and 9B are diagrams of a wearable display device as an image display apparatus;

FIGS. 10A and 10B are diagrams of a wearable display device as an image display apparatus;

FIG. 11 is a diagram of a wearable display device as an image display apparatus;

FIGS. 12A and 12B are diagrams of a wearable display device as the image display apparatus;

FIGS. 13A and 13B are diagrams each illustrating a head-up display as an image display apparatus; and

FIG. 14 is a diagram of a head-up display as an image display apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, color tone variations in the displayed color image can be corrected, enabling display of an image with a desired color temperature, irrespective of any positional deviations of the optical elements in the light source from their designed alignment.

One or more embodiment of the present disclosure are described below.

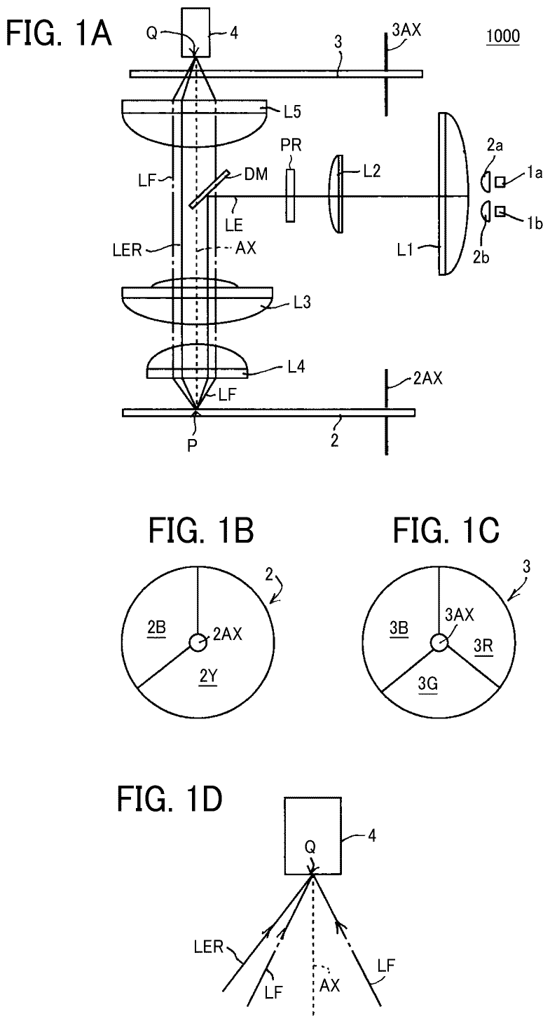

A configuration of a light source device 1000 is described with reference to FIGS. 1A, 1B, 1C, and 1D.

FIG. 1A illustrates the configuration of the light source device 1000, light emitters 1a and 1b and condensing lenses 2a and 2b.

The light emitters 1a and 1b, which are semiconductor laser diodes (LDs) or light-emitting diodes (LEDs), emit excitation light. In this example, the excitation light is blue light.

The condensing lenses 2a and 2b are microlenses that convert blue laser beams emitted from the light emitters 1a and 1b into parallel beams. The excitation beams passed through the microlenses (or the condensing lenses 2a and 2b) are further transmitted through lenses L1 and L2, and then enter a beam profiler PR, becoming an excitation beam LE.

Although two light emitters 1a and 1b are used in FIG. 1A, the number of light emitters is not limited to two. Three or more light emitters may be used. The number of light emitters is determined appropriately according to the color image to be displayed. For example, when an image display apparatus for displaying a color image is a projector for large-screen display, multiple arrays of light emitters are used. However, if the image display apparatus is a wearable display, as will be described later, a single light emitter may be sufficient.

As described above, the excitation beams passed through the microlenses (or the condensing lenses 2a and 2b) are further transmitted through the lenses L1 and L2, combined into a single light beam, and then enter a beam profiler PR, forming an excitation beam LE.

The beam profiler PR is formed by, for example, a microlens array in which microlenses with rectangular apertures are arranged in two-dimensional array. The beam profiler PR adjusts the shape of the excitation beam to resemble the aspect ratio of the rectangular microlenses.

In some examples, an excitation light source unit (or an excitation light source) may be configured without using the beam profiler PR.

The light emitters 1a and 1b, the microlenses (or the condensing lenses 2a and 2b), the lenses L1 and L2, and the beam profiler PR constitute an excitation light source unit (or referred to simply as an excitation light source) that emits excitation light from multiple light emitters and converts the emitted light into an excitation beam LE.

The excitation light emitted from lens L2 and shaped in cross-section by the beam profiler PR becomes an excitation beam LE and enters a dichroic mirror DM.

The dichroic mirror DM has a function of transmitting one of the excitation beam LE and fluorescence LF, which will be described later, while reflecting the other. In the example described, the dichroic mirror DM serves to reflect the excitation beam LE and transmit the fluorescence LF.

The excitation beam LE reflected by the dichroic mirror DM enters a lens L3, then passes through a lens L4, and is focused onto a focal point P on a wavelength converter to form a condensed spot. The lenses L3 and L4 form a first condensing optical system.

In the described example, the beam profiler PR shapes the condensed spot to resemble the shape of its microlenses.

FIG. 1A indicates an optical axis AX of the first condensing optical system formed by the lens L3 and the lens L4.

The wavelength converter is a disk-shaped phosphor wheel 2.

The light source device 1000 further includes a disk-shaped color wheel 3 as a color separator.

FIG. 1B illustrates the incident surface of the phosphor wheel 2 on which the excitation beam is focused. The disk-shaped phosphor wheel 2 is rotatable around a rotation axis 2AX.

The focal point P, which corresponds to the condensed spot of the excitation beam LE, is the point where the optical axis AX intersects the incident surface of the phosphor wheel 2.

The incident surface of the phosphor wheel 2 is divided into two fan-shaped areas 2B and 2Y around the rotation axis 2AX. The fan-shaped area 2B having an opening angle of 120 degrees serves as a reflection portion (or a reflector) that reflects the excitation beam LE focused onto it. The fan-shaped area 2B is hereinafter also referred to as a reflection region.

The fan-shaped area 2Y has an opening angle of 240 degrees, and a fluorescent layer is formed on it.

The fan-shaped area 2Y corresponds to a phosphor layer. In the following description, the fan-shaped area 2Y is referred to also as a phosphor region.

The fluorescent layer in the phosphor region (or the fan-shaped area 2Y) emits fluorescence of a color corresponding to a lower frequency than the excitation light when irradiated with the excitation beam LE. In the example, the excitation light is blue light, and the fluorescence emitted by the fluorescent layer is yellow light, which has a lower frequency than the blue light. The yellow light includes a red component and a green component. In the following description, the red component is also referred to as red fluorescence, and the green component is also referred to as green fluorescence.

As illustrated in FIG. 1A, the surface of the phosphor wheel 2 is perpendicular to the optical axis AX of the first condensing optical system.

When the excitation beam LE enters the reflection region (or the fan-shaped area 2B) of the phosphor wheel 2, the excitation beam LE is reflected symmetrically with respect to the optical axis AX, and then passes through the first condensing optical system in the order of the lens L4 and the lens L3, becoming the reflected excitation light LER.

The reflected excitation light LER passes through a lens L5, then passes through a blue-transmitting area of the color wheel 3, and is focused onto a focal point or focal position Q on the incident surface of the light homogenizer 4. The lens L5 forms a second condensing optical system.

When the excitation beam LE is focused onto the phosphor region (or the fan-shaped area 2Y) of the phosphor wheel 2, the yellow fluorescence LF is emitted. The fluorescence LF, originating from the focal point P of the excitation beam LE, spreads in a conical shape with the focal point P as its apex and the optical axis AX as its central axis. The fluorescence LF passes through the first condensing optical system, enters the lens L5 of the second condensing optical system, and is then focused onto the focal point Q on the incident surface of the light homogenizer 4 through the color wheel 3. At this time, a part of the fluorescence LF is transmitted through the dichroic mirror DM.

The lenses L3 and L4 of the first condensing optical system and the lens L5 of the second condensing optical system share the optical axis AX. These lenses L3, L4, and L5 form an imaging optical system, in which the focal points P and Q are optically conjugate. The focal point P corresponds to the object point, and the focal point Q corresponds to the image point.

The color wheel 3 as a color separator is described with reference to FIG. 1C.

The color wheel 3 has three fan-shaped areas 3B, 3R, and 3G having an opening angle of 120 degrees. The fan-shaped area 3B is an area that selectively transmits blue light as excitation light, and is referred to also as a bule light transmitting area. The fan-shaped area 3R is an area that selectively transmits red fluorescence contained in the yellow fluorescence LF, and is referred to also as a red light transmitting area. The fan-shaped area 3G is an area that selectively transmits green fluorescence contained in the fluorescence LF, and is referred to also as a green light transmitting area.

When viewed along the optical axis AX, the color wheel 3 overlaps the phosphor wheel 2. The blue light transmitting area (i.e., the fan-shaped area 3B) of the color wheel 3 overlaps the reflection region (i.e., the fan-shaped area 2B) of the phosphor wheel 2. The fluorescent region (i.e., the fan-shaped area 2Y) overlaps a region formed by combining the red light transmitting area (i.e., the fan-shaped area 3R) and the green light transmitting area (i.e., the fan-shaped area 3G).

The phosphor wheel 2 and the color wheel 3 rotate at the same speed while maintaining alignment of the overlapping areas. At this time, when the phosphor wheel 2 is irradiated with excitation light, the color wheel 3 sequentially receives the blue excitation light LER reflected by the reflection region (i.e., the fan-shaped area 2B) and the yellow fluorescence LF emitted from the fluorescent region (i.e., the fan-shaped area 2Y) of the phosphor wheel 2.

The phosphor wheel 2 and the color wheel 3 rotate at the same speed while maintaining alignment of the overlapping areas. This allows the blue light (or the excitation light), the red fluorescence, and the green fluorescence to sequentially strike the incident surface of the light homogenizer 4 at the equal time intervals.

The light homogenizer 4 is an optical element such as an integrator rod or a light tunnel. A typical example is a hollow light guide member having a rectangular cross-sectional light guide region in the form of a rectangular parallelepiped. When convergent light is incident from the entrance side, the light is guided through repeated total reflection on the inner walls of the light guide region. Since the incident angles of the individual light rays differ, the light rays mix during the guiding process through multiple reflections. As a result, blue, red, and green light beams with uniform intensity distributions are emitted sequentially and repeatedly from the exit end.

By irradiating an image display device, such as a digital micromirror device (DMD), with these light beams as illumination light, blue, red, and green image beams for a color image can be obtained, thus enabling the formation of a color image. The color image is formed as a combination of the three primary color images displayed sequentially and perceived by the viewer as a residual image.

FIG. 1D illustrates both the fluorescence LF and the reflected excitation light LER being focused onto a focal point Q on the incident surface of the light homogenizer 4.

The light source device illustrated in FIGS. 1A, 1B, 1C, and 1D includes an excitation light source unit that emits excitation light from light emitters 1a and 1b, and defines the emitted light as an excitation beam LE; and a wavelength converter. The wavelength converter includes a reflection region (or the fan-shaped area 2B) that reflects the excitation beam LE, and a fluorescent region (or the fan-shaped area 2Y) that emits fluorescence LF having a wavelength different from that of the excitation light.

The light source device also includes a dichroic mirror DM that transmits the fluorescence LF and reflects the excitation beam LE; a first condensing optical system (i.e., the lenses L3 and L4) that condenses the excitation beam LE onto the wavelength converter through the dichroic mirror DM; a second condensing optical system (i.e., the lens L5) that condenses the fluorescence LF and the excitation light LER reflected from the wavelength converter through the first condensing optical system; and a light homogenizer 4 that homogenizes the reflected excitation light LER and the fluorescence LF condensed by the second condensing optical system.

As illustrated in FIG. 1A, the excitation beam LE passes through one half of the optical effective surface of the first condensing optical system on one side of the optical axis AX (i.e., the right portion of the lenses L3 and L4 relative to the optical axis AX in FIG. 1A). The excitation light LER, reflected from the wavelength converter, passes through the opposite side of the optical effective surface of the first condensing optical system relative to the optical axis AX (i.e., the left portion of the lenses L3 and L4 in FIG. 1A). The second condensing optical system shares the optical axis AX with the first condensing optical system.

As illustrated in FIG. 1A, the excitation beam LE entering the first condensing optical system is a thin light beam with a small cross section, and its principal ray is parallel to the optical axis AX. The excitation light LER is also a thin light beam and is parallel to the optical axis AX. The fluorescence LF is a light beam with a small cross section including the optical axis AX between the lenses L3 and L5.

The configuration described with reference to FIGS. 1A and 1B includes the color wheel 3; however, the color wheel may be omitted. For example, if the phosphor region (or the fan-shaped area 2Y), which is the phosphor layer of the phosphor wheel, is divided into two equal fan-shaped areas: one emitting red fluorescence and the other emitting green fluorescence, light of the three primary colors (blue, red, and green) can be obtained without using a color wheel, and these can be directly condensed onto the incident surface of the light homogenizer 4.

An example configuration of the light source has been described above.

The following describes the color tone variation to be corrected by one or more embodiment of the present disclosure.

Since the light source device described above is constructed by combining various optical components, manufacturing errors are unavoidable during the assembly process. That is, the positional relationships between the optical components cannot be perfectly aligned with the design specifications. The light source device described with reference to FIGS. 1A, 1B, 1C, and 1D includes the phosphor wheel 2 and the color wheel 3 as movable components, so misalignment between optical components may also occur over time.

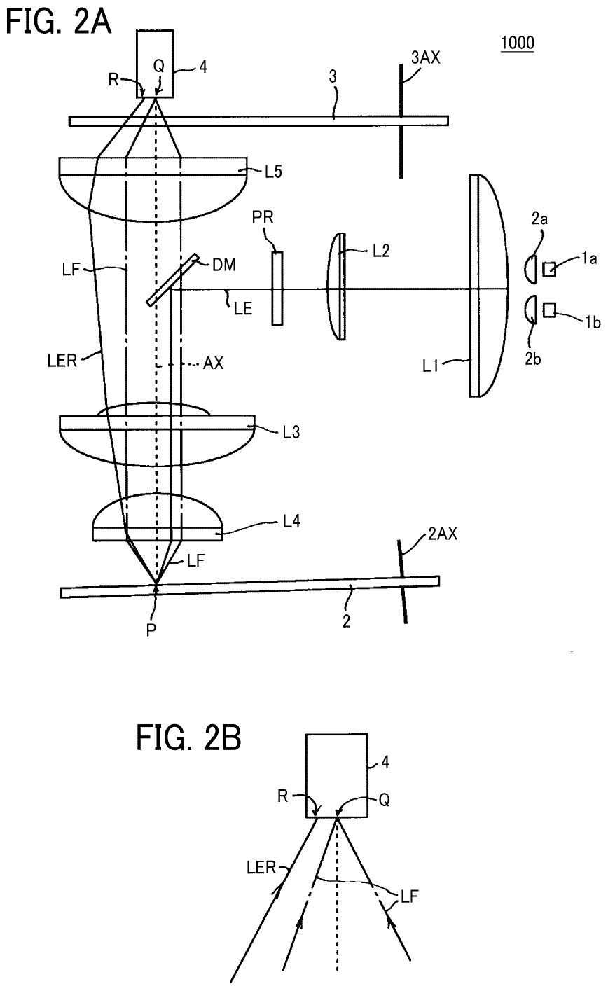

As one example, FIGS. 2A and 2B illustrate the case where a slight tilt angle Δθ occurs in the rotation axis 2AX of the phosphor wheel 2.

As illustrated in FIG. 2A, the excitation beam LE is focused on the focal point P on the incident surface of the phosphor wheel 2. When the excitation beam LE enters the phosphor region (or the fan-shaped area 2Y), the fluorescence LF is emitted. When the excitation beam LE enters the reflection region (or the fan-shaped area 2B), the beam is reflected as reflected excitation light LER. In FIG. 2A, the slight tilt of the phosphor wheel is exaggerated for illustrative purposes.

At this time, the fluorescence LF diverges in a conical shape, and its incident position on the incident surface of the light homogenizer 4 is almost identical to the focal point Q illustrated in FIGS. 1A, 1B, 1C, and 1D.

The reflected excitation light LER experiences a change in incident angle, by twice the tilt angle Δθ of the phosphor wheel 2). Thus, its optical path through the imaging optical system formed by the lenses L3, L4, and L5 differs from the case where Δθ=0. Since the optical path of the reflected excitation light LER changes in this manner, its optical path deviates from the so-called paraxial region of the imaging optical system. As a result, the optical path is affected by optical aberrations, and its incident position on the entrance surface of the light homogenizer 4 becomes different from the focal point Q of the fluorescence LF, shifting to a different position R, as illustrated in FIG. 2B.

That is, the separation between the incident position (or the focal point Q) of the fluorescence LF and the incident position R of the reflected excitation light LER on the incident surface of the light homogenizer 4 results in different light homogenizing effects for the fluorescence LF and the reflected excitation light LER.

For example, when the light homogenizing effect of the light homogenizer 4 on the reflected excitation light LER is weaker than that on the fluorescence LF, the intensity of the blue component is relatively lower than that of the fluorescence (i.e., the red and green components) emitted from the light homogenizer 4. Thus, the displayed color image has a weaker blue component and appears reddish. This is the color tone variation.

As the tilt angle Δθ remains small, the separation between the focal points Q and R is also small, resulting in minor color tone variation. However, as Δθ increases, the color tone variation exceeds the acceptable range and involves the need for correction.

The following describes an embodiment that corrects such color tone variation.

In one embodiment, at least one of the position or orientation of an optical element on the optical path of the excitation light LE in the excitation light source unit, the dichroic mirror DM, or the wavelength converter is adjusted, allowing the focal positions or points of the reflected excitation light LER and the fluorescence LF on the incident surface of the light homogenizer 4 to be aligned. This alignment enables correction of the color tone variation.

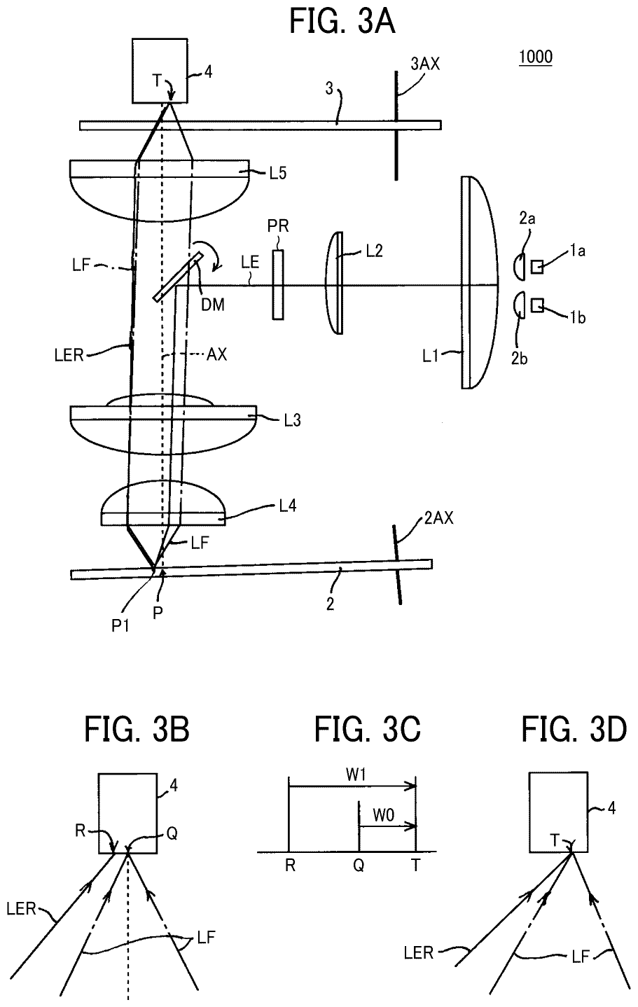

FIGS. 3A, 3B, 3C, and 3D illustrate an embodiment in which the dichroic mirror DM is rotated and its orientation is changed.

As illustrated in FIGS. 3A, 3B, 3C, and 3D, the dichroic mirror DM is rotated clockwise by a minute angle from the state illustrated in FIGS. 2A and 2B.

At this time, the focal position of the excitation beam LE on the phosphor wheel 2 is shifted to the left from the designed position P to be a position P1.

With this shift, the position P1 serves as the object point for the imaging optical system, and the fluorescence LF is focused at position T on the incident surface of the light homogenizer 4.

By finely adjusting the rotation angle of the dichroic mirror DM, the focal point of the reflected excitation light LER can be aligned with a position T. This ensures that the focal positions of both the fluorescence LF and the reflected excitation light LER coincide at position T, thus correcting any color tone variation.

FIG. 3B is a diagram illustrating the focal points R and Q on the incident surface of the light homogenizer 4, as described above, before the correction of the color tone variation. As illustrated in FIG. 3C, when the rotation angle of the dichroic mirror DM increases in the clockwise direction, the focal points R and Q shift to the right in the drawing. In this case, the focal point R moves by an amount W1, which is greater than the amount W0 of the focal point Q, in response to the rotation angle of the dichroic mirror DM.

As a result, adjusting the rotation angle of the dichroic mirror DM allows the focal points of the reflected excitation light LER and the fluorescence LF to be aligned at the position T, as illustrated in FIG. 3D.

In this way, the color tone variation caused by the tilt of the phosphor wheel 2 can be corrected.

In the above description, the displacement W1 of the focal point of the reflected excitation light LER is greater than the displacement W0 of the focal point of the fluorescence LF because the optical path of the reflected excitation light lies farther from the paraxial region than that of the fluorescence. As a result, the reflected excitation light LER is more affected by aberrations in the imaging optical system formed by the lenses L3, L4, and L5.

As is clear from the above description, in one or more embodiments, the optical paths of the reflected excitation light LER and the fluorescence LF within the imaging optical system are separated, creating a difference in the degree to which the aberrations of the imaging optical system affect each light. By doing so, the focal points of the reflected excitation light LER and the fluorescence LF are brought closer together or aligned, and the color tone is corrected.

In one embodiment described above, the color tone is corrected by aligning the focal point R of the reflected excitation light LER with the focal point Q of the fluorescence LF. However, color tone correction may not involve aligning the focal points R and Q of the reflected excitation light LER and the fluorescence LF. Even if the focal points R and Q of the reflected excitation light LER and the fluorescence LF are not exactly aligned, the color tone can be adjusted by controlling the distance between the focal points R and Q.

In the above, the focal points R and Q of the reflected excitation light LER and the fluorescence LF on the incident surface of the light homogenizing element 4 were described as points. However, in reality, the focal spots of the reflected excitation light LER and the fluorescence LF are small-area regions, and the focal points R and Q represent the centroids of these small-area regions.

If the majority of the small-area regions of the focal points Q and R are positioned within the incident surface of the light homogenizer 4, that is, if the centroid positions of the focal spots of the reflected excitation light LER and the fluorescence LF fall within the aperture accepted by the light homogenizer 4, then the color tone correction can be properly achieved.

That is, the statement that the focal point R of the reflected excitation light LER and the focal point Q of the fluorescence LF are adjustable means that at least the centroid position of the fluorescence LF and the centroid position of the reflected excitation light LER can be adjusted to lie within the aperture of the light homogenizer 4. If these centroid positions deviate from the aperture of the light homogenizer 4, both the reflected excitation light LER and the fluorescence LF will become light that does not effectively contribute to illumination. As a result, the ratio between the fluorescent component and the blue component may significantly deviate from the intended value, potentially falling outside the acceptable color tone range.

To separate the optical paths of the reflected excitation light LER and the fluorescence LF within the imaging optical system, it is sufficient to shift the incident position of the excitation beam LE on the phosphor wheel 2 from the designed focal point P. This can be achieved by changing the direction of the excitation beam LE, its distance from the optical axis AX, or the distance between the phosphor wheel 2 and the lens L4.

In other words, it is sufficient to adjust at least one of the position and orientation of any one of the following: the optical elements on the optical path of the excitation light in the excitation light source unit (for example, the lens L1, the lens L2, the beam profiler PR as in FIG. 1A), the dichroic mirror DM, or the phosphor wheel 2.

The embodiments in FIGS. 3A, 3B, 3C, and 3D described above employ a method that rotates the dichroic mirror DM in a direction perpendicular to its mirror normal (i.e., its orientation is changed) to alter the direction of the excitation beam LE. In other words, the orientation of the dichroic mirror is rotatably adjustable about an axis perpendicular to a mirror normal of the dichroic mirror.

The dichroic mirror DM can also be moved, for example, horizontally or vertically from the positions illustrated in FIGS. 3A, 3B, 3C, and 3D, to change the position of the excitation beam LE relative to the optical axis AX.

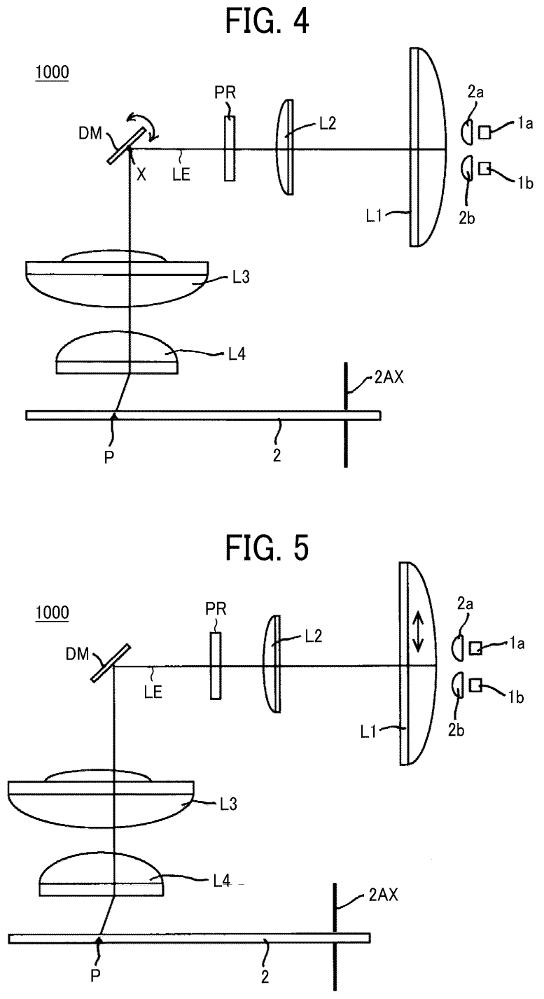

In cases where the dichroic mirror DM is rotated, as in the examples illustrated in FIGS. 3A, 3B, 3C, and 3D, it is preferable, as illustrated in FIG. 4, to align the rotation axis of the dichroic mirror DM with the incident position X of the excitation beam LE from the excitation light source unit. The rotation axis of the dichroic mirror DM is along a direction perpendicular to the plane of the drawing.

This reduces changes in the optical path length and minimizes the impact on optical characteristics, allowing color temperature adjustment while maintaining high image quality.

The embodiment in FIG. 5 allows the position of the lens L1 to be adjusted in a direction perpendicular to the optical axis. The lens L1 is one of the optical elements in the optical path of the excitation light within the excitation light source unit, including the light emitters 1a and 1b, the microlenses 2a and 2b, the lenses L1 and L2, and the beam profiler PR.

By doing so, the position and direction of the excitation beam LE incident on the dichroic mirror DM can be changed, allowing the direction and position of the excitation beam LE entering the lens L3 to be adjusted. As a result, the incident position of the excitation beam LE on the incident surface of the phosphor wheel 2 can be shifted relative to the point P.

In the excitation light source unit, a lens L2 or a beam profiler PR, instead of the lens L1, may be displaced in a direction perpendicular to the optical axis. Alternatively, the lens orientation may be adjusted by tilting the optical axis of the lens L1 or the lens L2.

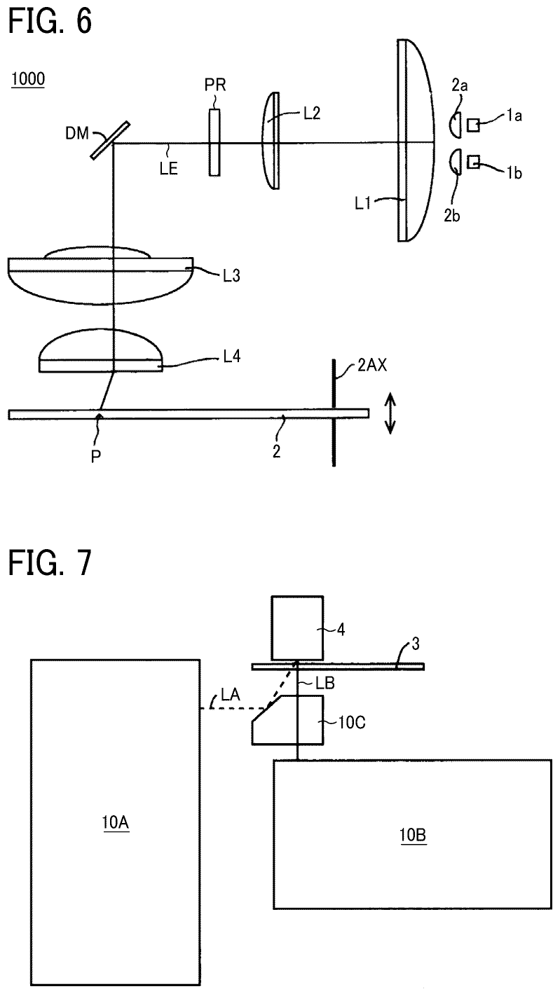

The embodiment in FIG. 6 is an example in which the phosphor wheel 2 is slightly displaced in the direction of the rotation axis 2AX to shift the incident position of the excitation beam LE relative to the point P. In this manner, the focal position of the excitation beam LE can also be shifted in the horizontal direction of the figure relative to the point P.

Instead of displacing the phosphor wheel 2 in the direction of its rotation axis 2AX, or in combination with such displacement, the orientation of the phosphor wheel 2 may be changed by slightly tilting the rotation axis 2AX.

In the embodiment described above, at least one of the position and orientation of each of the optical element L1, the dichroic mirror DM, and the phosphor wheel 2 in the optical path of the excitation light in the excitation light source unit is adjusted. Such an adjustment mechanism can be implemented using any known suitable rotation or displacement adjustment mechanism. The adjustment operation may be performed manually or automatically using a stepping motor.

The parts not illustrated in FIGS. 4 to 6 are the same as those in FIGS. 1A to 1D.

The light source device described above is a single unit. However, in some examples, two units, each of which excludes the light homogenizer 4 and the color wheel 3, are used, and the light homogenizer 4 and the color wheel 3 shared between the two units, thus achieving a high-output light source device.

FIG. 7 illustrates such a configuration.

FIG. 7 illustrates unit light sources 10A and 10B: portions each excluding the light homogenizer 4 and the color wheel 3 from the light source device described above; and a light combiner 10C.

The light beams LA and LB from the unit light sources 10A and 10B are reflected excitation light and fluorescence, respectively. These light beams are combined by the light combiner 10C, pass through the shared color wheel 3, and enter the incident surface of the shared light homogenizer 4.

The light combiner 10C totally reflects the emitted light LA and transmits the emitted light LB.

The unit light sources 10A and 10B are arranged so that the emitted light beams LA and LB are orthogonal to each other in a plane parallel to the drawing.

Using two unit light sources 10A and 10B enables higher-brightness color image display. However, if the color temperatures of the two unit light sources are not equivalent, the quality of the displayed color image may degrade.

By adjusting the incident positions of the reflected excitation light and fluorescence from the unit light sources 10A and 10B on the incident surface of the light homogenizer 4, high-brightness and high-quality color image display can be achieved.

An embodiment of an image display apparatus using the above-described light source device is described below.

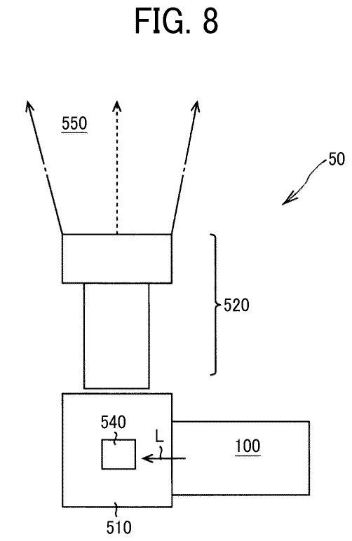

FIG. 8 is a diagram illustrating a projector 50 as an image display apparatus that projects and displays a color image.

The projector 50 includes a light source unit 100 as an example of a light source device, an illumination optical system 510, and a projector 520.

The light source unit 100 may be any of the light source devices described above and emits the light L into the illumination optical system 510. The light L is an illumination light beam homogenized by the light homogenizer 4 described above for the light source device, and is time-divided into blue light (excitation light), red light (fluorescent component), and green light (fluorescent component).

The light modulator 540 is, for example, a DMD that controls the tilt of a two-dimensional array of tiny mirrors, expressing the blue, red, and green image components in synchronization with the corresponding components of the light L.

The light L is sequentially converted by the light modulator 540 into blue, red, and green component image light beams, which are then sequentially projected and focused onto a screen by the projector 520.

The light modulator 540 may also use a liquid crystal panel instead of a DMD.

In FIG. 8, the direction in which the projector 520 projects a projection image is orthogonal to the optical-axis direction of the light L emitted from the light source unit 100. That is, the light source unit 100 is arranged so that the optical axis of the light L emitted from the light source unit 100 is perpendicular to the arrangement direction of the illumination optical system 510 and the projector 520, and the light L is directly introduced into the illumination optical system 510.

The layout of each component may be changed as appropriate, depending on the arrangement of elements such as the cooler, the controller, and power supply that make up the projector 50.

For example, when the light modulator 540 uses a transmissive light modulation element, such as a transmissive liquid crystal panel, the light L from the light source unit 100 may be configured to enter the light modulator 540 from below, as illustrated in FIG. 8.

The projector 50 includes the light source unit 100. This allows the illuminance of the light L emitted from the light source unit 100 to be set lower than a predetermined level, reducing deterioration of the light source caused by its operation.

By setting the illuminance lower than the predetermined illuminance, the lifespan of the light source unit 100 is extended. This reduces the frequency of replacing the light source unit 100 and lowers the maintenance requirements for the projector 50.

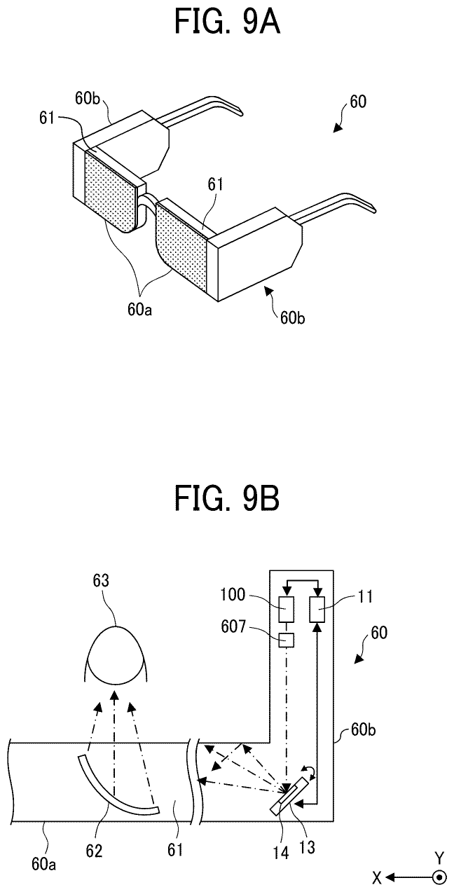

FIGS. 9A and 9B are diagrams of a wearable display device as an image display apparatus. The wearable display device 60 has an appearance as illustrated in FIG. 9A.

The illustrated wearable display device 60 is a head-mounted display, resembling glasses or goggles, that can be worn on a human head.

In FIG. 9A, the wearable display device 60 is configured with a pair of front portions 60a and temple portions 60b, arranged substantially symmetrically on the left and right sides. Each of the front portions 60a includes a light guide plate 61. An optical system, a controller, and another component are incorporated in the temple portion 60b.

FIG. 9B is a schematic diagram illustrating a portion of the wearable display device 60 (i.e., the left-eye section illustrated in FIG. 9A). The right-eye section is the same as the left-eye section.

The wearable display device 60 includes a control device 11, a light source unit 100, a light-intensity adjuster 607, a movable device 13 with a reflecting surface 14, a light guide plate 61, and a semi-reflective mirror 62.

The light source unit 100 is any of the above-described light sources.

The light intensity of light from the light source unit 100 is adjusted by the light-intensity adjuster 607, and the adjusted light is incident on the movable device 13. The movable device 13 moves the reflecting surface 14 in the XY-direction based on signals from the control device 11, enabling two-dimensional scanning of the light emitted from the light source unit 100. The drive control of the movable device 13 is synchronized with the light emission timing of the light source in the light source unit 100. The emission timing is determined based on the upper portion of the image to be displayed.

The scanning light by the movable device 13 is incident on the light guide plate 61. The light guide plate 61 reflects the scanning light on the inner wall and guides the scanning light to the semi-reflective mirror 62. The light guide plate 61 is formed from a material such as a resin having transparency at the wavelength of the scanning light.

The semi-reflective mirror 62 reflects light from the light guide plate 61 toward the rear surface of the wearable display device 60 and directs the light toward the eye 63 of the wearer of the wearable display device 60. The semi-reflective mirror 62 has, for example, a free-form surface shape. An image formed by the scanning light is reflected by the semi-reflective mirror 62 and projected onto the retina of the eye 63 of the wearer. Alternatively, the reflection at the semi-reflective mirror 62 and the effect of the crystalline lenses of eyeballs causes the image of the scanning light to be formed on the retina of the eye 63 of the wearer.

Further, the reflection by the semi-reflective mirror 62 can correct spatial distortion in the image. The wearer can observe an image formed by the light of scanning in the XY-direction.

Using the semi-reflective mirror 62, the wearer can observe an image formed by light from the outside world superimposed with an image created by the scanning light. Alternatively, a regular mirror may replace the semi-reflective mirror 62 to block external light, allowing the wearer 63 to see only the image created by the scanning light.

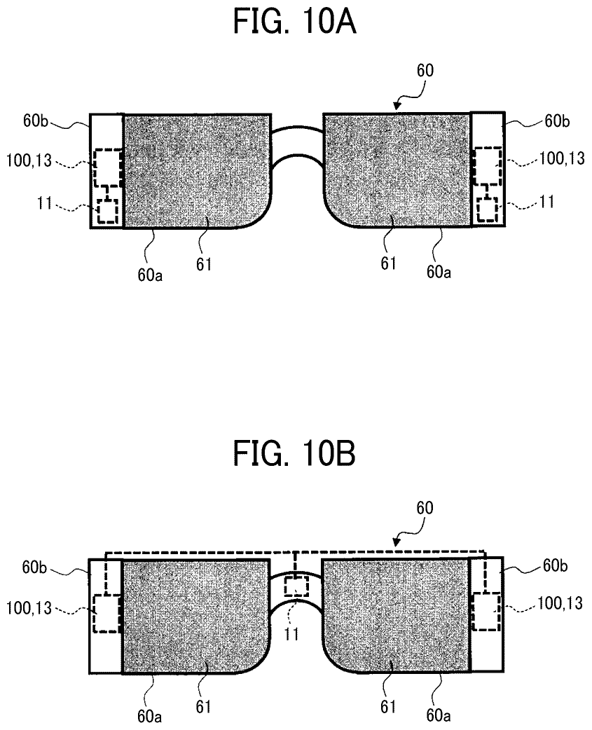

FIGS. 10A and 10B are schematic diagrams of a configuration of a wearable display device 60. Like reference numerals are used for like elements in FIGS. 9A and 9B, as there is no risk of confusion.

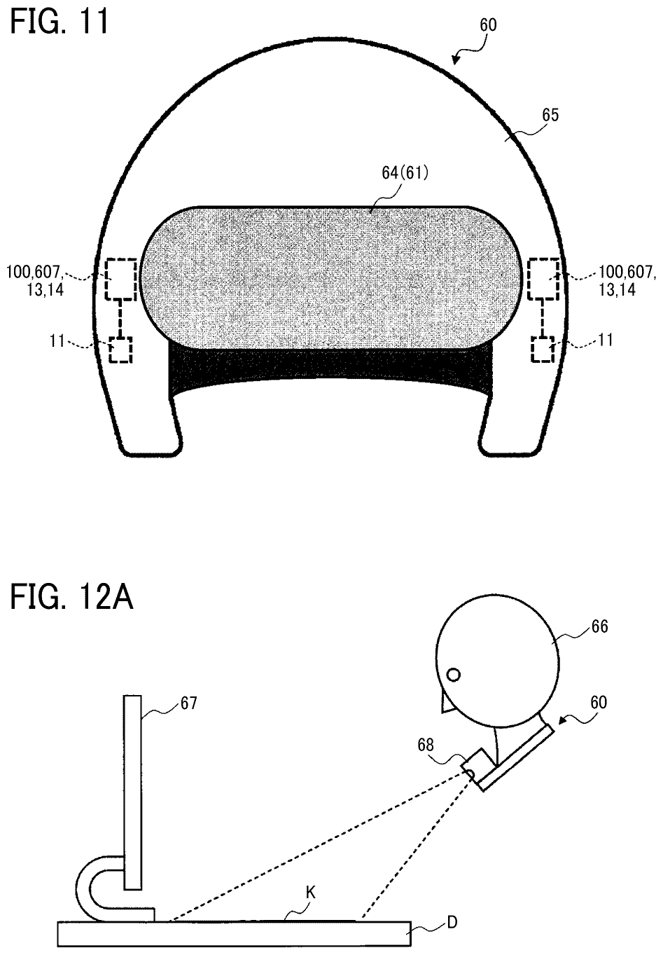

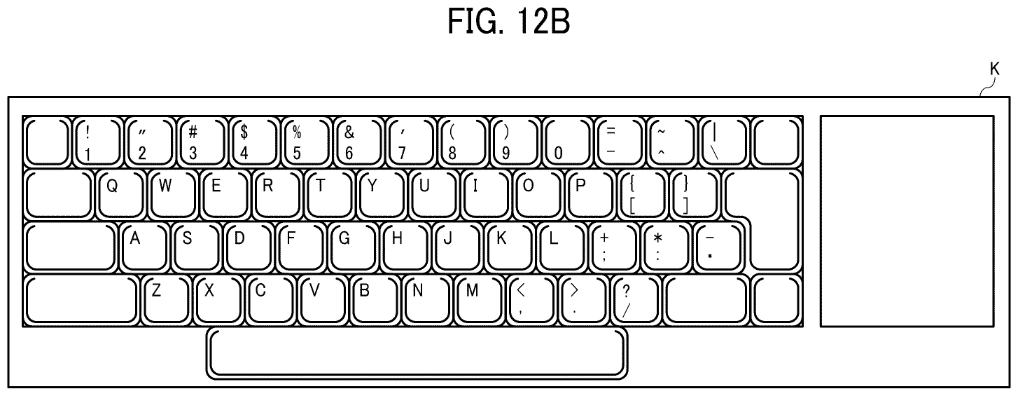

The same applies to FIG. 11, FIG. 12A, and FIG. 12B.

As illustrated in FIG. 10A, a control device 11 included in a wearable display device 60 is installed in each of the left and right temple portions 60b so as to correspond to the light source unit 100 and the movable device 13 incorporated in each of the left and right temple portions 60b.

Further, as illustrated in FIG. 10B, a single control device 11 may be installed at the central position (e.g., an intermediate position between the left and right light guide plates 61) of the wearable display device 60. Further, the control device 11 may control the light source unit 100 and the movable device 13 incorporated into each of the temple portions 60b.

FIG. 11 illustrates a configuration of a wearable display device 60, which is in the form of a helmet 65 provided with a visor 64 including a light guide plate 61.

In this case, the light source unit 100, the light-intensity adjuster 607, the movable device 13, the reflecting surface 14, and the control device 11 may be built in a helmet 65 as illustrated in FIG. 11.

FIGS. 12A and 12B are schematic diagrams of a configuration of a wearable display device 60.

The wearable display device 60 illustrated in FIGS. 12A and 12B is a neckband-type display device designed to be worn around a neck or shoulder area of a person.

In FIGS. 12A and 12B, a wearer 66 is sitting in front of a display 67 placed on a desk D while wearing a wearable display device 60.

The display 67 communicates with the wearable display device 60 via short-range wireless communication, such as Bluetooth, and outputs a display signal.

The wearable display device 60 is equipped with a projector 68, which projects an image K of an input keyboard onto the upper surface of the desk D, as illustrated in FIG. 12B. The projector 68 is similar to the projector 50 illustrated in FIGS. 9A and 9B, and includes as the light sources described above.

The wearable display device 60 is equipped with a camera in addition to the projector 68. The camera detects the movement of the fingers of the wearer 66 on the image K of the input keyboard projected onto the upper surface of the desk D.

Information on the detection result from the camera is transmitted to the control device of the wearable display device 60, for example. The control device then determines which key of the input keyboard is pressed by the wearer 66 based on the information received from the camera and instructs the display 67 to display information corresponding to the determination result.

The following describes a head-up display as an image display apparatus.

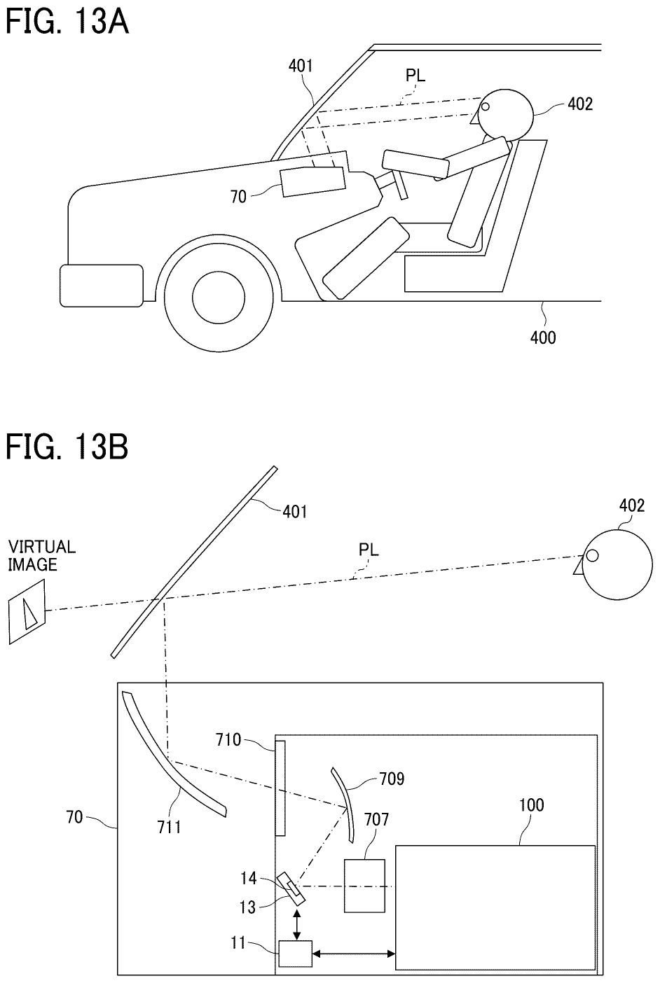

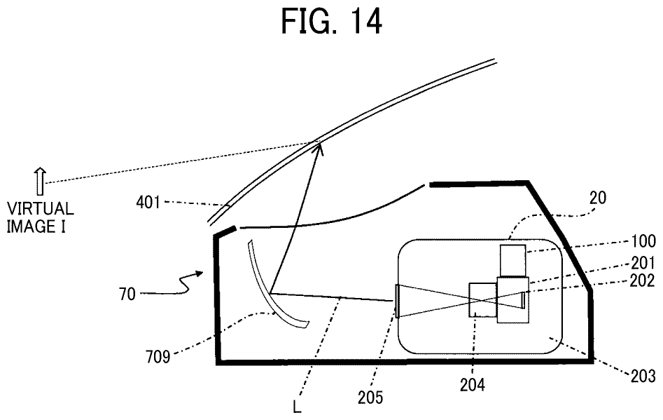

FIGS. 13A and 13B are schematic diagrams of a vehicle 400 mounted with a head-up display 70 according to an embodiment of the present disclosure.

As illustrated in FIG. 13A, the head-up display 70 is disposed, for example, near a windshield 401 of the vehicle 400. A projection light beam PL emitted from the head-up display 70 is reflected by the windshield 401 and directed to an observer (e.g., a driver 402) that is a user. This allows the driver 402 to visually recognize, for example, an image projected by the head-up display 70, as a virtual image. Alternatively, a combiner may be disposed on the inner wall surface of the windshield 401 so that the user can visually recognize a virtual image formed by the projection light that is reflected by the combiner.

As illustrated in FIG. 13B, the head-up display 70 includes the light source unit 100 as a light source device. The light source unit 100 is a light source device described above.

The light emitted from the light source unit 100 is deflected by the movable device 13 having the reflecting surface 14 after passing through a light-intensity adjuster 707. The deflected laser beams pass through a projection optical system including a free-form surface mirror 709, an intermediate screen 710, and a projector mirror 711, and are projected onto the windshield 401.

The head-up display 70 described above projects an intermediate image displayed on the intermediate screen 710 on the windshield 401 of the vehicle 400 so that the driver 402 can be visually recognized the intermediate image as a virtual image.

The light emitted from the light source unit 100 is adjusted in intensity by light-intensity adjuster 707, and then two-dimensionally scanned by the movable device 13 with the reflecting surface 14. The projection light, which has been two-dimensionally scanned by the movable device 13, is reflected by the free-form mirror 709, corrected for distortion, and then focused onto the intermediate screen 710 to display an intermediate image. The intermediate screen 710 includes a microlens array in which microlenses are two-dimensionally arranged, and enlarges the projection light incident on the intermediate screen 710 in units of microlens.

The movable device 13 causes the reflecting surface 14 to biaxially reciprocate and two-dimensionally scan with the light L incident on the reflecting surface 14. The drive control of the movable device 13 is synchronized with the light emission timing of a light emitter (e.g., a semiconductor laser) in the light source unit 100.

FIG. 14 is illustrates a configuration of a head-up display 70.

As illustrated in FIG. 14, the head-up display 70 includes an imager 20 and a concave mirror 709.

The imager 20 includes the light source unit 100 as a light source device.

The light emitted from the light source unit 100 is, for example, directed to an image former 202 after passing through an illumination system 201. The image former 202 includes a light modulator, such as a digital mirror device (DMD) or a liquid crystal panel. A control device 203 controls light emission driving of a light source (a light emitter) included in the light source unit 100 and driving of the light modulator included in the image former 202. The image generated by the image former 202 forms an intermediate image on an intermediate screen 205 by a projection lens 204.

The head-up display 70 of FIG. 14 reflects the image formed on the intermediate screen 205 onto the windshield 401 of the vehicle via the concave mirror 709 and causes the driver 402 to visually recognize a virtual image I. A turning mirror may be placed between the concave mirror 709 and the windshield 401 as needed in view of layout.

The intermediate screen 205 is configured by, for example, a microlens array in which microlenses are two dimensionally arranged. In the present embodiment, the microlens array is used to control the viewing angle characteristics, and enhances the viewing angle characteristics of the image projected onto the intermediate screen 205, generating a brighter virtual image.

Although the desirable embodiments and examples of the disclosure have been described above, the disclosure is not particularly limited to such specific embodiments and examples unless otherwise particularly limited in the above description, and various modifications and changes can be made without departing from the spirit and scope of the disclosure as set forth in the appended claims.

The image display apparatus is not limited to the above configurations of the projector, the wearable display device, and the head-up display. The image display apparatus is not limited to being mounted on a vehicle or the human body. The image display apparatus may also be mounted on, for example, a railroad vehicle, an aircraft, or a ship; a mobile object such as a robot, drone, or unmanned aerial vehicle capable of autonomous or remote-controlled movement; or a non-mobile object such as a work robot that operates a driving target, such as a manipulator, without changing its position.

In addition, the embodiments of the present disclosure are not limited to the configurations described above, such as combinations with other elements in the configurations described in the above embodiments.

For example, by using the color tone correction function of the light source device, the color tone of the displayed color image can be adjusted from the standard color temperature a preferred tone.

Aspects of the present disclosure are as follows, for example.

### Aspect 1

A light source device includes an excitation light source including: one or more light emitters to emit excitation light; and an optical element to convert the excitation light, emitted from the one or more light emitters, into an excitation beam; a wavelength converter including: a reflector to reflect the excitation beam; and a phosphor layer to emit fluorescence having a wavelength different from a wavelength of the excitation beam; a dichroic mirror to: transmit the fluorescence; and reflect the excitation beam; a light homogenizer having an incident surface to homogenize the excitation beam and the fluorescence incident on the incident surface; a first condensing optical system having an optical axis to: transmit the excitation beam reflected from the dichroic mirror through one half of an optical effective surface of the first condensing optical system relative to the optical axis; and condense the excitation beam onto the wavelength converter; a second condensing optical system having the optical axis to: condense the excitation beam, reflected from the reflector of the wavelength converter and transmitted through an opposite half of the optical effective surface of the first condensing optical system relative to the optical axis, onto a first focal position on the incident surface of the light homogenizer; and condense the fluorescence emitted from the phosphor layer of the wavelength converter onto a second focal position on the incident surface of the light homogenizer. At least one of a position or an orientation of one of the optical element of the excitation light source; the dichroic mirror; or the wavelength converter is adjustable to adjust the first focal position of the excitation beam and the second focal position of the fluorescence on the incident surface of the light homogenizer.

### Aspect 2

In the light source device according to Aspect 1, at least one of the position or the orientation of the optical element of the excitation light source is adjustable.

### Aspect 3

In the light source device according to Aspect 1, at least one of a position or an orientation of the dichroic mirror is adjustable.

### Aspect 4

In the light source device according to Aspect 1, at least one of a position or an orientation of the wavelength converter is adjustable.

### Aspect 5

In the light source device according to Aspect 3, the orientation of the dichroic mirror is rotatably adjustable about an axis perpendicular to a mirror normal of the dichroic mirror.

### Aspect 6

In the light source device according to Aspect 5, a rotation axis of the dichroic mirror coincides with a reflection point of the excitation beam on the dichroic mirror.

### Aspect 7

The light source device according to Aspect 1, further includes a color separator, the one or more light emitters emit the excitation light of blue light, the phosphor layer of the wavelength converter emits the fluorescence of yellow light containing a green component and a red component, and the color separator separates the excitation beam and the fluorescence into the blue light, the green component and the red component.

### Aspect 8

A light source device includes two light source units; a light homogenizer; and a light combiner. Each of the two light source units includes: an excitation light source including: one or more light emitters to emit excitation light; and an optical element to convert the excitation light, emitted from the one or more light emitters, into an excitation beam; a wavelength converter including: a reflector to reflect the excitation beam; and a phosphor layer to emit fluorescence having a wavelength different from a wavelength of the excitation beam; a dichroic mirror to: transmit the fluorescence; and reflect the excitation beam; a first condensing optical system having an optical axis to: transmit the excitation beam reflected from the dichroic mirror through one half of an optical effective surface of the first condensing optical system relative to the optical axis; and condense the excitation beam onto the wavelength converter; a second condensing optical system having the optical axis to: condense the excitation beam, reflected from the reflector of the wavelength converter and transmitted through an opposite half of the optical effective surface of the first condensing optical system relative to the optical axis, onto a first focal position on an incident surface of a light homogenizer. The light homogenizer has an incident surface and homogenizes the excitation beam and the fluorescence incident on the incident surface. The light combiner combines the excitation beam and the fluorescence emitted from each of the two light source units. The light homogenizer and the light combiner are shared between the two light source units.

### Aspect 9

An image display apparatus includes the light source device according to any of Aspects 1 to 7.

### Aspect 10

An image display apparatus includes the light source device according to Aspect 8.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A light source device comprising:
an excitation light source including:
one or more light emitters to emit excitation light; and
an optical element to convert the excitation light, emitted from the one or more light emitters, into an excitation beam;
a wavelength converter including:
a reflector to reflect the excitation beam; and
a phosphor layer to emit fluorescence having a wavelength different from a wavelength of the excitation beam;
a dichroic mirror to:
transmit the fluorescence; and
reflect the excitation beam;
a light homogenizer having an incident surface to homogenize the excitation beam and the fluorescence incident on the incident surface;
a first condensing optical system having an optical axis to:
transmit the excitation beam reflected from the dichroic mirror through one half of an optical effective surface of the first condensing optical system relative to the optical axis; and
condense the excitation beam onto the wavelength converter;
a second condensing optical system having the optical axis to:
condense the excitation beam, reflected from the reflector of the wavelength converter and transmitted through an opposite half of the optical effective surface of the first condensing optical system relative to the optical axis, onto a first focal position on the incident surface of the light homogenizer; and
condense the fluorescence emitted from the phosphor layer of the wavelength converter onto a second focal position on the incident surface of the light homogenizer,
wherein at least one of a position or an orientation of one of:
the optical element of the excitation light source;
the dichroic mirror; or
the wavelength converter,
is adjustable to adjust the first focal position of the excitation beam and the second focal position of the fluorescence on the incident surface of the light homogenizer.

2. The light source device according to claim 1,
wherein at least one of the position or the orientation of the optical element of the excitation light source is adjustable.

3. The light source device according to claim 1,
wherein at least one of a position or an orientation of the dichroic mirror is adjustable.

4. The light source device according to claim 1,
wherein at least one of a position or an orientation of the wavelength converter is adjustable.

5. The light source device according to claim 3,
wherein the orientation of the dichroic mirror is rotatably adjustable about an axis perpendicular to a mirror normal of the dichroic mirror.

6. The light source device according to claim 5,
wherein a rotation axis of the dichroic mirror coincides with a reflection point of the excitation beam on the dichroic mirror.

7. The light source device according to claim 1, further comprising a color separator, wherein
the one or more light emitters emit the excitation light of blue light,
the phosphor layer of the wavelength converter emits the fluorescence of yellow light containing a green component and a red component, and
the color separator separates the excitation beam and the fluorescence into the blue light, the green component and the red component.

8. A light source device comprising:
two light source units each including:
an excitation light source including:
one or more light emitters to emit excitation light; and
an optical element to convert the excitation light, emitted from the one or more light emitters, into an excitation beam;
a wavelength converter including:
a reflector to reflect the excitation beam; and
a phosphor layer to emit fluorescence having a wavelength different from a wavelength of the excitation beam;
a dichroic mirror to:
transmit the fluorescence; and
reflect the excitation beam;
a first condensing optical system having an optical axis to:
transmit the excitation beam reflected from the dichroic mirror through one half of an optical effective surface of the first condensing optical system relative to the optical axis; and
condense the excitation beam onto the wavelength converter;
a second condensing optical system having the optical axis to:
condense the excitation beam, reflected from the reflector of the wavelength converter and transmitted through an opposite half of the optical effective surface of the first condensing optical system relative to the optical axis, onto a first focal position on an incident surface of a light homogenizer; and
condense the fluorescence emitted from the phosphor layer of the wavelength converter onto a second focal position on the incident surface of the light homogenizer;
a light homogenizer having an incident surface to homogenize the excitation beam and the fluorescence incident on the incident surface; and
a light combiner to combine the excitation beam and the fluorescence emitted from each of the two light source units, wherein
the light homogenizer and the light combiner are shared between the two light source units.

9. An image display apparatus comprising the light source device according to claim 1.

10. An image display apparatus comprising the light source device according to claim 8.
